(19) United States
(12) Patent Application Publication
(10) Pub. No.: US 2025/0200978 A1
(43) Pub. Date: Jun. 19, 2025

(54) TRAFFIC FLOW ANALYSIS DEVICE, TRAFFIC FLOW ANALYSIS METHOD, AND PROGRAM RECORDING MEDIUM

(71) Applicant: NEC Corporation, Minato- ku, Tokyo (JP)

(72) Inventors: Naoko FUKUSHI, Tokyo (JP); Shintaro CHIKU, Tokyo (JP); Shuei YAMADA, Tokyo (JP); Masanori KUKI, Tokyo (JP); Shuhei MIZUGUCHI, Tokyo (JP); Kosei KOBAYASHI, Tokyo (JP)

(73) Assignee: NEC Corporation, Minato- ku, Tokyo (JP)

(21) Appl. No.: 18/849,593

(22) PCT Filed: Mar. 29, 2022
(86) PCT No.: PCT/JP2022/015321

§ 371 Date: Sep. 23, 2024

(51) Int. Cl. G06V 20/54; G06V 10/56; G06V 10/764; G06V 20/52; G06V 40/10

(52) U.S. Cl. CPC G06V 20/54; G06V 10/56; G06V 10/764; G06V 20/53; G06V 40/10; G06V 2201/08

(57) ABSTRACT

A traffic flow analysis device according to the present invention includes: a memory configured to store instructions; and one or more processors configured to execute the instructions to: acquire an image from a camera installed at a location where a moving object subject to traffic flow analysis is configured to be imaged; store a plurality of types of identification methods for identifying an attribute of the moving object captured by the camera; select an identification method suitable for a tendency of the moving object captured by the camera from the plurality of types of stored identification methods; and identify a moving object appearing in the acquired image and an attribute of the moving object using the selected identification method.

### TECHNICAL FIELD

The present invention relates to a traffic flow analysis device, a traffic flow analysis method, and a program recording medium.

### BACKGROUND ART

PTL 1 discloses a flow of people prediction device that can robustly predict a flow of people with respect to a change in a space. According to the literature, a flow of people prediction device selects, based on a prediction condition including the prediction target period to be predicted and the allowable condition related to the feature of a prediction model created in advance, the prediction model from the model storage means. The flow of people prediction device predicts a flow of people data under the prediction condition based on the selected prediction model.

### CITATION LIST

### Patent Literature

PTL 1: WO 2021/130926 A1

### SUMMARY OF INVENTION

### Technical Problem

PTL 1 describes prediction of a flow of people using a prediction model, but does not mention a detailed analysis of a traffic flow including persons and vehicles, particularly a measure for improving the accuracy thereof.

An object of the present invention is to provide a traffic flow analysis device, a traffic flow analysis method, and a program recording medium capable of improving analysis accuracy of persons and vehicles constituting a traffic flow.

### Solution to Problem

According to a first aspect, provided is a traffic flow analysis device including an acquisition means for acquiring an image from a camera installed at a location where a moving object subject to traffic flow analysis is configured to be imaged, a storage means for storing a plurality of types of identification methods for identifying an attribute of the moving object captured by the camera, a selection means for selecting an identification method suitable for a tendency of the moving object captured by the camera from the plurality of types of identification methods stored in the storage means, and an identification means for identifying a moving object appearing in the acquired image and an attribute of the moving object using the identification method selected by the selection means.

According to a second aspect, provided is a traffic flow analysis method including selecting, from a plurality of types of identification methods stored in a storage means storing the plurality of types of identification methods for identifying an attribute of a moving object captured by the camera installed at a location where the moving object subject to traffic flow analysis is configured to be imaged, an identification method suitable for a tendency of the moving object captured by the camera, acquiring an image from the camera, and identifying an attribute of a moving object appearing in the acquired image using the selected identification method.

According to a third aspect, provided is a program recording medium for causing a computer to execute the steps of selecting, from a plurality of types of identification methods stored in a storage means storing the plurality of types of identification methods for identifying an attribute of a moving object captured by the camera installed at a location where the moving object subject to traffic flow analysis is configured to be imaged, an identification method suitable for a tendency of the moving object captured by the camera, acquiring an image from the camera, and identifying an attribute of a moving object appearing in the acquired image using the selected identification method.

### Advantageous Effects of Invention

According to the present invention, there are provided a traffic flow analysis device, a traffic flow analysis method, and a program recording medium capable of improving analysis accuracy of persons and vehicles constituting a traffic flow.

### BRIEF DESCRIPTION OF DRAWINGS

FIG. 1 is a diagram illustrating a configuration of an example embodiment of the present invention.

FIG. 2 is a flowchart illustrating operations of an example embodiment of the present invention.

FIG. 3 is a diagram for describing operations of an example embodiment of the present invention.

FIG. 4 is a diagram illustrating a configuration of a traffic flow analysis device according to a first example embodiment of the present invention.

FIG. 5 is a diagram illustrating an arrangement example of a traffic flow analysis device and a camera according to the first example embodiment of the present invention.

FIG. 6 is a diagram for describing operations of selecting a classification model according to the first example embodiment of the present invention.

FIG. 7 is a flowchart illustrating operations of the traffic flow analysis device according to the first example embodiment of the present invention.

FIG. 8 is a diagram illustrating a configuration of a traffic flow analysis device according to a second example embodiment of the present invention.

FIG. 9 is a diagram for describing operations of selecting a classification model according to the second example embodiment of the present invention.

FIG. 10 is a flowchart illustrating operations of a traffic flow analysis device according to the second example embodiment of the present invention.

FIG. 11 is a diagram illustrating a configuration of a traffic flow analysis device according to a third example embodiment of the present invention.

FIG. 12 is a diagram for describing operations of selecting a classification model according to the third example embodiment of the present invention.

FIG. 13 is a flowchart illustrating operations of the traffic flow analysis device according to the third example embodiment of the present invention.

FIG. 14 is a diagram illustrating a configuration of a traffic flow analysis device according to a fourth example embodiment of the present invention.

FIG. 15 is a diagram illustrating an example of arrangement of facilities around an intersection where a camera is installed according to the fourth example embodiment of the present invention.

FIG. 16 is a diagram for describing operations of selecting a classification model according to the fourth example embodiment of the present invention.

FIG. 17 is a flowchart illustrating operations of the traffic flow analysis device according to the fourth example embodiment of the present invention.

FIG. 18 is a diagram illustrating a configuration of a traffic flow analysis device according to a fifth example embodiment of the present invention.

FIG. 19 is a diagram for describing operations of selecting a classification model according to the fifth example embodiment of the present invention.

FIG. 20 is a diagram illustrating a configuration of a computer that can function as the traffic flow analysis device of the present invention.

### EXAMPLE EMBODIMENT

First, an outline of an example embodiment of the present invention will be described with reference to the drawings. The reference numerals in the drawings attached to this outline are attached to respective elements for convenience as an example for assisting understanding, and are not intended to limit the present invention to the illustrated aspects. Connection lines between blocks in the drawings and the like referred to in the following description include both bidirectional and unidirectional. The unidirectional arrow schematically indicates a flow of a main signal (data), and does not exclude bidirectionality. The program is executed via a computer device, and the computer device includes, for example, a processor, a storage device, an input device, a communication interface, and a display device as necessary. The computer device is configured to be able to communicate with equipment (including a computer) inside or outside the device via a communication interface regardless of wired or wireless. Although there are ports and interfaces at connection points of input and output of each block in the drawing, illustration thereof is omitted.

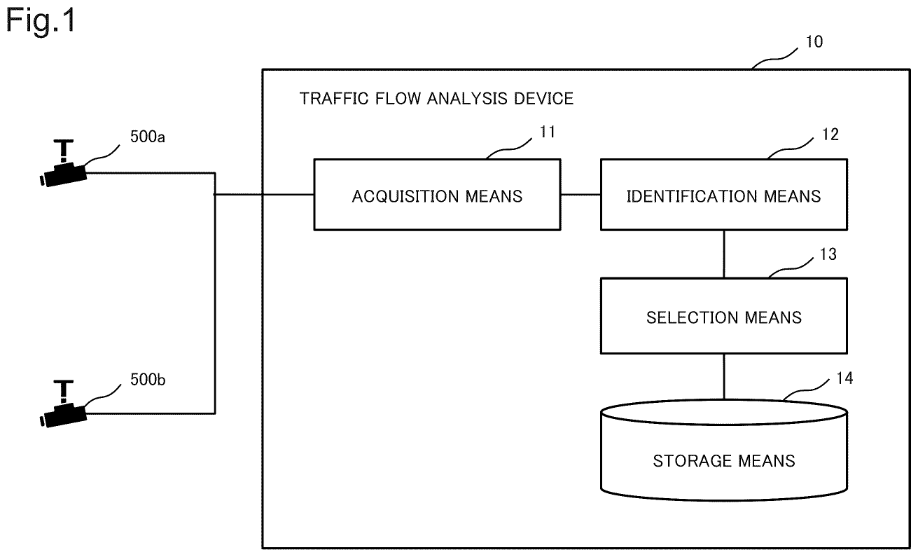

In an example embodiment of the present invention, as illustrated in FIG. 1, the present invention can be achieved by a traffic flow analysis device 10 connected to one or more cameras 500a and 500b. More specifically, the traffic flow analysis device 10 includes an acquisition means 11, a storage means 14, a selection means 13, and an identification means 12.

The acquisition means 11 acquires images from the cameras 500a and 500b installed at locations where a moving object to be subjected to traffic flow analysis can be imaged.

The storage means 14 stores a plurality of types of identification methods for identifying the attribute of the moving object captured by each of the cameras 500a and 500b. Very simply, the storage means 14 stores a classification model and a processing algorithm for identifying the gender and the age group of the person captured by each of the cameras 500a and 500b. The classification model can be created by various types of machine learning using teacher data in which an image of a person captured by each of the cameras 500a and 500b is associated with attribute information (correct answer data) of the person. The processing algorithm can include an algorithm optimized based on the tendency of a flow of people assumed to be captured by each of the cameras 500a and 500b.

The selection means 13 selects an identification method suitable for the tendency of the moving object captured by each of the cameras 500a and 500b from the plurality of types of identification methods stored in the storage means 14. The identification means 12 identifies the moving object appearing in the acquired image and its attribute (class) by using the identification method selected by the selection means 13.

In the above configuration, the plurality of types of the identification methods stored in the traffic flow analysis device 10 is created based on the tendency of the moving object captured by each of the cameras 500a and 500b investigated in advance, and the selection means 13 selects the identification method from the plurality of types of identification methods using a selection rule determined to be suitable for the tendency of the moving object captured by each of the cameras 500a and 500b.

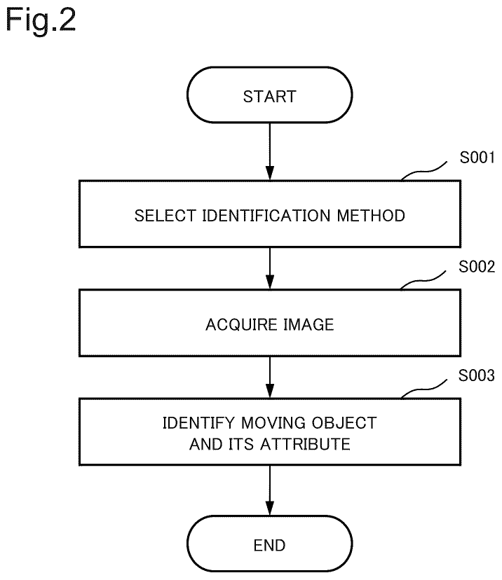

Subsequently, a traffic flow analysis method used in the traffic flow analysis device 10 of the present example embodiment will be described in detail with reference to the drawings. FIG. 2 is a flowchart illustrating operations of the traffic flow analysis device 10. First, the traffic flow analysis device 10 selects an identification method from the plurality of types of identification methods (step S001). At this time, a traffic flow analysis device 100 selects an identification method using a selection rule determined to select an identification method suitable for the tendency of the moving object captured by each of the cameras 500a and 500b.

Next, the traffic flow analysis device 10 acquires image data from the cameras 500a and 500b (step S002). The traffic flow analysis device 10 identifies the moving object and its attribute information from the acquired image data using the selected identification method (step S003). In the example of FIG. 2, it is described that the moving object and the attribute information thereof are collectively identified, but the identification of the moving object and the identification of the attribute of the moving object may be separately performed. In this case, the traffic flow analysis device 10 detects the moving object from a frame difference or the like constituting an image, cuts out an image of the detected moving object, and performs identification processing.

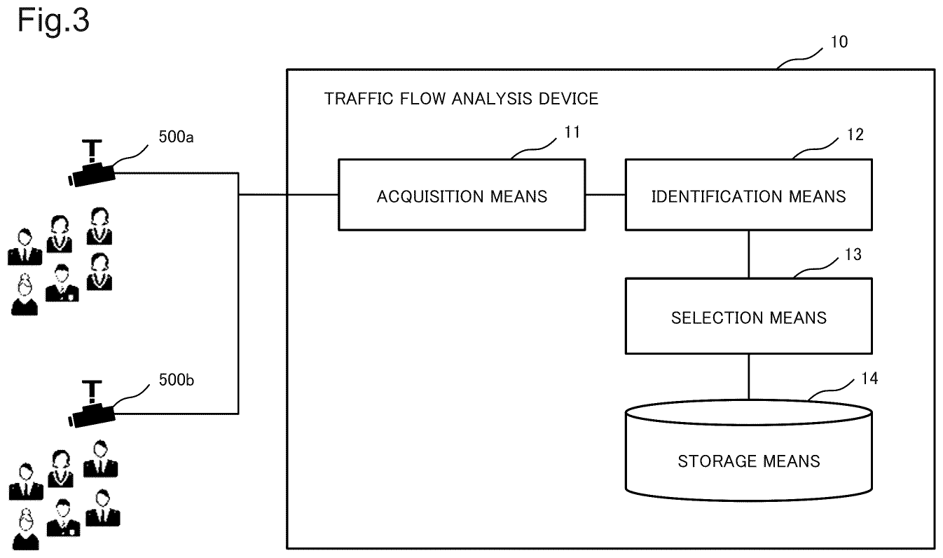

Operations of selecting the identification method using the selection rule will be described. FIG. 3 is a diagram for describing the operations of an example embodiment of the present invention. For example, it is assumed that the camera 500a is installed at a place where the traffic volume of women is large in the past statistical data. On the other hand, it is assumed that the camera 500b is installed at a place where the traffic volume of men is large in the past statistical data. In this case, the selection means 13 selects an identification method suitable for a place where the female traffic volume is large for analysis of image data acquired from the camera 500a. As a result, the identification accuracy of the moving object and its attribute information from the image data acquired from the camera 500a can be improved. Similarly, the selection means 13 selects an identification method suitable for a place where the male traffic volume is large for analysis of image data acquired from the camera 500b. As a result, the identification accuracy of the moving object and its attribute information from the image data acquired from the camera 500b can be improved.

As described above, according to the present example embodiment, the traffic flow analysis device 10 selects an identification method suitable for the tendency of the moving object captured by each of the cameras 500a and 500b, and analyzes the traffic flow. As a result, it is possible to improve the analysis accuracy of persons and vehicles constituting the traffic flow.

In the above description, it is described that the identification method is selected, but as an aspect of the identification method, a similar effect can be obtained by changing a classification model or a processing algorithm for identifying a moving object.

In the above description, it is described that the identification method is changed by the cameras 500a and 500b that have captured image data, but the identification method can also be changed by other conditions. For example, in a case where the analysis target is changed from a person to a vehicle, the identification method can be changed. In addition, for example, in a case where a camera is installed at a certain intersection, the identification method may be changed by turning on a signal or the like related to the analysis target in such a way that persons are analyzed during a green light and vehicles are analyzed during a red light. The identification method may be changed according to an analysis time zone or the like related to the analysis target in such a way that persons are analyzed from morning to night, and vehicles are analyzed from midnight to early morning. Of course, selection conditions of these identification methods may be determined as a selection rule, and the traffic flow analysis device 10 may select the identification method with reference to the selection rule.

In the above-described example embodiment, an example in which the moving object includes a person is described, but the moving object is not limited to a person. For example, the moving object may be a vehicle, a bicycle or other light vehicle, an unmanned aerial vehicle (UAV), an unmanned others vehicle, or the like.

In the above-described example embodiment, it is described that a plurality of types of identification methods for identifying the attribute of the moving object is set in advance in the storage means 14, but it is desirable that these identification methods are appropriately added and updated to optimum ones. For example, a classification model or a processing algorithm having higher prediction accuracy is set in the storage means 14 periodically or when an event occurs, and the selection means 13 selects a more optimal classification model or processing algorithm. The periodical addition and update may be performed once a month, once a week, or the like. In addition, as the event, for example, in addition to the time of release and version upgrade of the processing algorithm of the classification model, the time of changing the required accuracy of the attribute identification due to a revision of a law or a change in the safety level is conceivable.

### First Example Embodiment

Next, a first example embodiment of the present invention in which a classification model is selected as an example of the identification method will be described in detail with reference to the drawings. In the following description, an example of selecting a classification model using a model selection rule for selecting a classification model based on the position of the camera will be described.

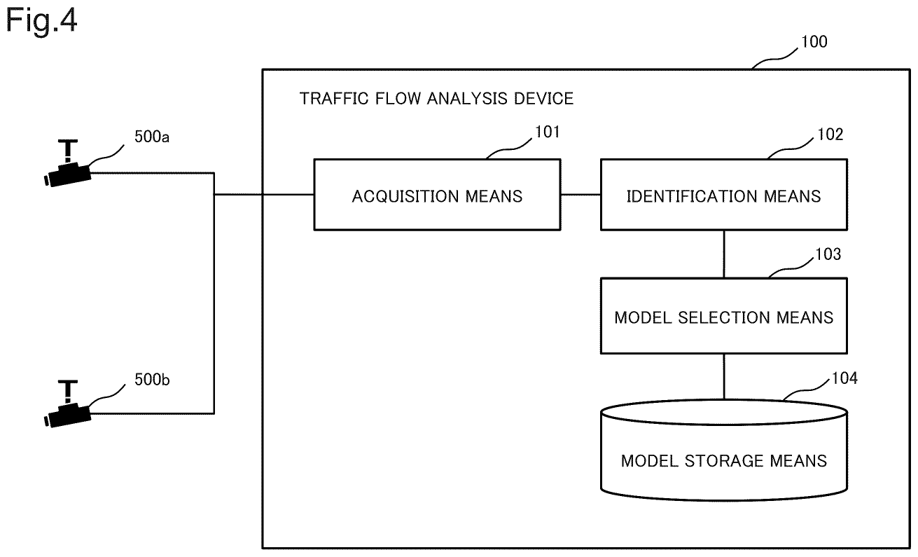

FIG. 4 is a block diagram illustrating a configuration of a traffic flow analysis device according to the first example embodiment of the present invention. The traffic flow analysis device 100 includes an acquisition means 101, a model storage means 104, a model selection means 103, and an identification means 102.

The acquisition means 101 acquires images from the cameras 500a and 500b installed at locations where moving objects to be subjected to traffic flow analysis can be imaged.

The model storage means 104 stores a plurality of types of classification models for identifying an attribute of the moving object captured by each of the cameras 500a and 500b. Very simply, the model storage means 104 stores a classification model for identifying the gender and the age group of the person captured by each of the cameras 500a and 500b. Such a classification model can be created by various types of machine learning using teacher data in which an image of a person captured by each of the cameras 500a and 500b is associated with attribute information (correct answer data) of the person.

The model selection means 103 selects a classification model from the model storage means 104. The identification means 102 identifies the moving object appearing in the acquired image and its attribute (class) using the classification model selected by the model selection means 103.

In the above configuration, a plurality of types of the classification models stored in the traffic flow analysis device 100 is created based on the tendency of the moving object captured by each of the cameras 500a and 500b investigated in advance, and the model selection means 103 selects the classification model from the plurality of types of classification models using a model selection rule determined to be suitable for the tendency of the moving object captured by each of the cameras 500a and 500b.

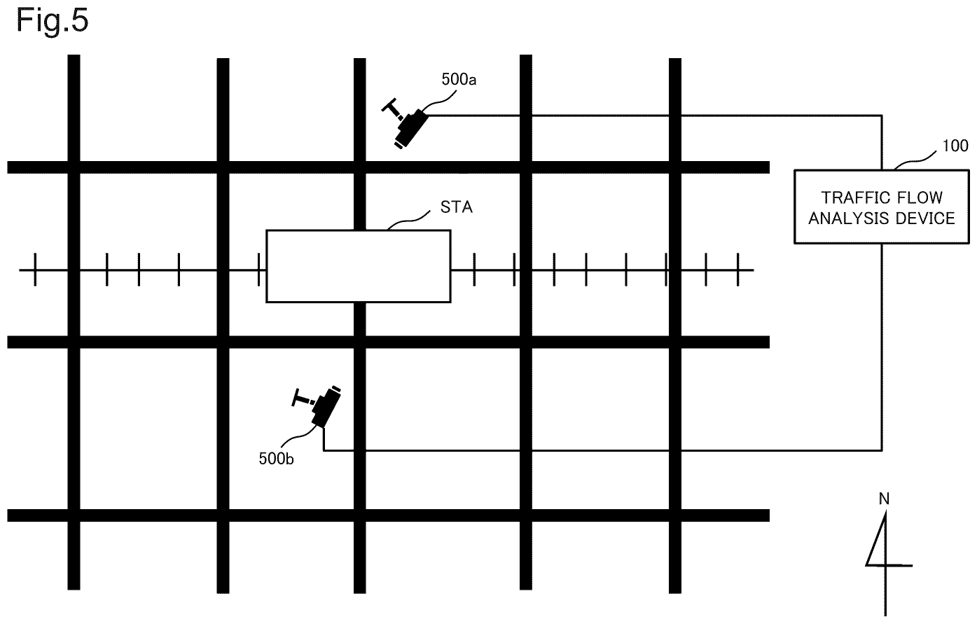

FIG. 5 is a diagram illustrating an arrangement example of the traffic flow analysis device 100 and the cameras 500a and 500b according to the first example embodiment of the present invention. As illustrated in FIG. 5, in the first example embodiment, the camera 500a is set on the north side of the station STA and can image a passerby. On the other hand, the camera 500b is set on the south side of the station STA, and can image a passerby. The traffic flow analysis device 100 can acquire an image captured by each of the cameras 500a and 500b, and analyzes a flow of people.

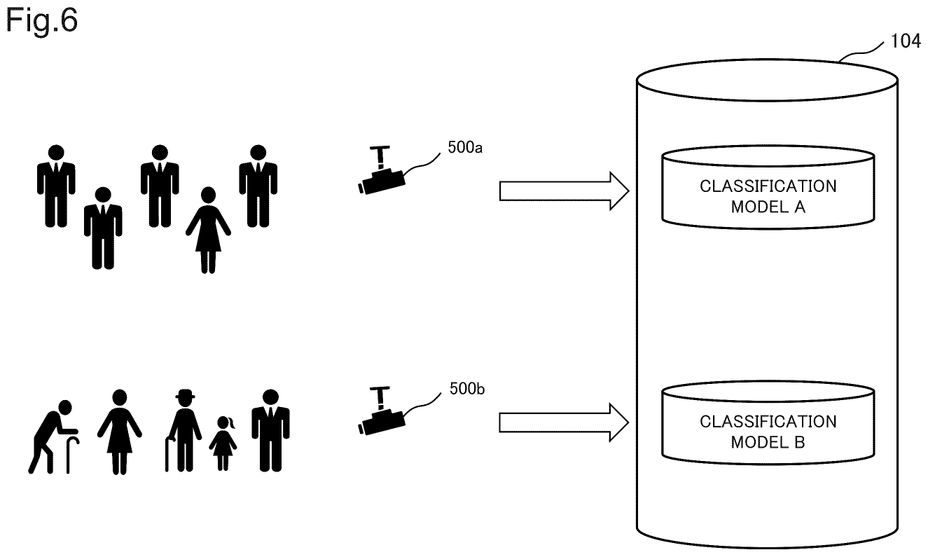

The configuration of the traffic flow analysis device 100 is substantially similar to the configuration of FIG. 1, and thus description thereof is omitted. FIG. 6 is a diagram for describing operations of selecting a classification model to the present example embodiment. The model storage means 104 of the present example embodiment stores a plurality of types of classification models for identifying an attribute of a pedestrian captured by each of the cameras 500a and 500b. Such a traffic flow analysis device 100 may be disposed for each area or each intersection. For example, it is possible to adopt a configuration in which the traffic flow analysis device 100 installed in each area or the vicinity of the area acquires and analyzes an image by a camera installed in a related area. Similarly, it is possible to adopt a configuration in which the traffic flow analysis device 100 installed at each intersection or near the intersection acquires and analyzes an image by a camera installed at the intersection. Such a traffic flow analysis device 100 may be one or more MEC servers that are disposed at an edge of a network to transmit analysis results to an information processing device disposed on a cloud. “MEC” is an abbreviation for Multi-access Edge Computing, or Mobile Edge Computing.

As illustrated in FIG. 6, in the present example embodiment, the model storage means 104 holds a classification model A and a classification model B. Classification model A is a classification model tuned for identifying an attribute of a pedestrian imaged by the camera 500a. Such a classification model can be actually created by performing machine learning using an image captured by the camera 500a (or an image captured at a similar position) and actual flow of people data (correct answer data) as teacher data. Similarly, the classification model B is a classification model tuned for identifying the attribute of the pedestrian imaged by the camera 500b.

The model selection means 103 of the present example embodiment selects a classification model using a model selection rule for selecting an appropriate classification model according to the installation positions of the cameras 500a and 500b. Specifically, the model selection means 103 selects the classification model A for the image captured by the camera 500a, and selects the classification model B for the image captured by the camera 500b.

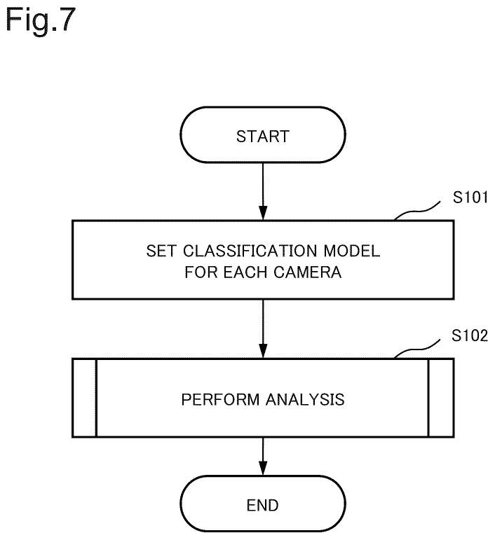

Next, operations of the present example embodiment will be described in detail with reference to the drawings. FIG. 7 is a flowchart illustrating the operations of the traffic flow analysis device 100 according to the first example embodiment of the present invention. Referring to FIG. 7, first, the traffic flow analysis device 100 selects a classification model for each camera and sets the classification model in the identification means 102 (step S101).

Thereafter, the traffic flow analysis device 100 repeats the process of detecting a pedestrian appearing in the image captured by each of the cameras 500a and 500b and identifying his or her attribute (step S102).

As described above, the model selection means 103 selects an appropriate classification model according to the installation positions of the cameras 500a and 500b. For example, as illustrated in FIG. 6, since there are many adults at the installation position of the camera 500a, the classification model A specialized for adults is selected. Since pedestrians with various attributes pass at the installation position of the camera 500b, the classification model B specialized for identification of these attributes is selected. As a result, the traffic flow analysis device 100 can accurately identify the attribute of the pedestrian.

### Second Example Embodiment

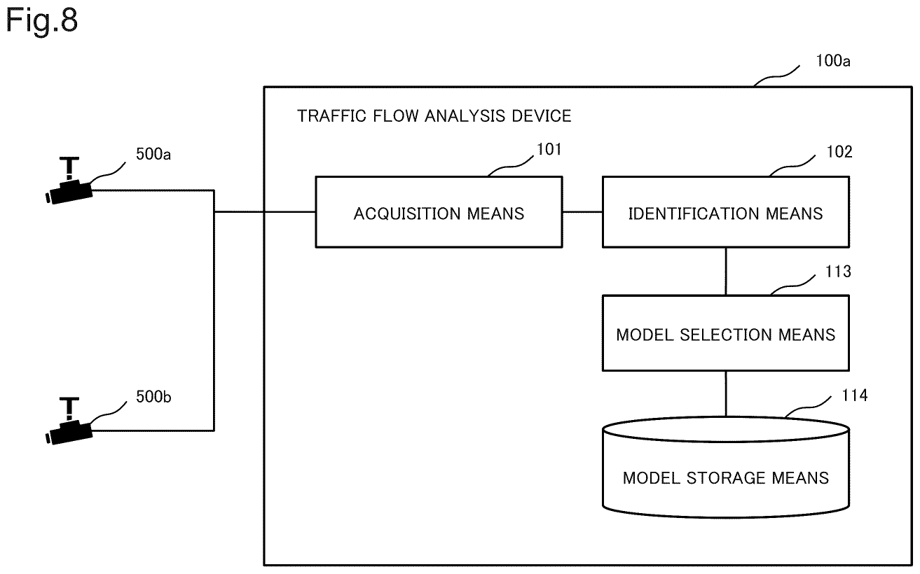

Next, a second example embodiment of the present invention in which a classification model is selected using a model selection rule for selecting the classification model based on a time zone in which an image is captured will be described in detail with reference to the drawings. FIG. 8 is a block diagram illustrating a configuration of a traffic flow analysis device 100a according to the second example embodiment of the present invention. A difference from the traffic flow analysis device of the first example embodiment illustrated in FIG. 2 is that a classification model for each time zone is stored in a model storage means 114, and a model selection means 113 selects a classification model according to a time zone in which analysis is performed in addition to installation positions of the cameras 500a and 500b. Since other configurations are similar to those of the first example embodiment, description thereof will be omitted, and differences will be mainly described below.

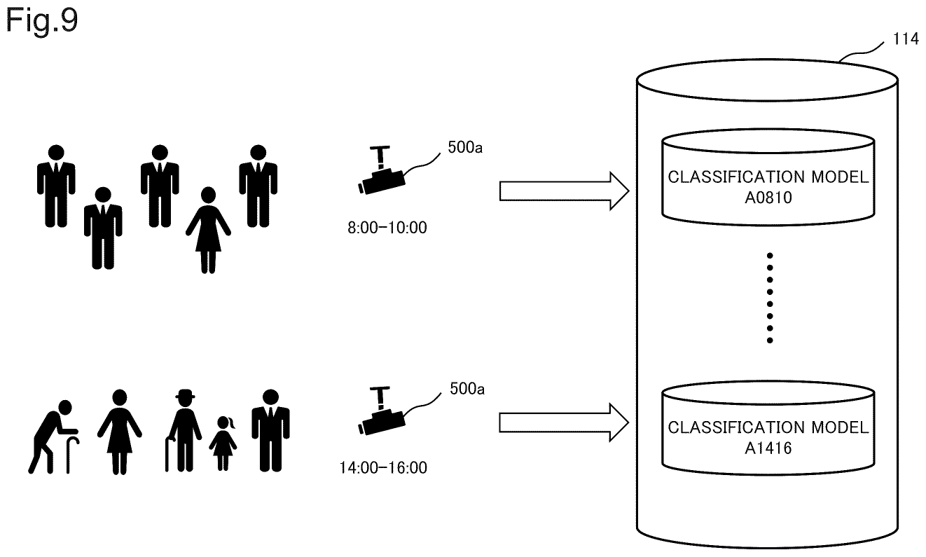

As illustrated in FIG. 9, in the present example embodiment, the model storage means 114 stores a plurality of classification models for each time zone, such as a classification model A0810 to a classification model A1416. The classification model A0810 is a classification model tuned for identifying an attribute of a pedestrian imaged by the camera 500a at 8:00-10:00. Similarly, the classification model A1416 is a classification model tuned for identifying an attribute of a pedestrian imaged by the camera 500a at 14:00-16:00. Such a classification model can be created by actually performing machine learning using an image captured in each time zone by the camera 500a (or an image captured at a similar position) and actual flow of people data (correct answer data) as teacher data.

In the example of FIG. 9, the classification models of two time zones of 8:00-10:00 and 14:00-16:00 are illustrated, but the classification model may be similarly stored in other time zones, or one classification model may be used in a plurality of time zones. In the example of FIG. 9, the classification model of the camera 500b is omitted, but a classification model for each time zone may also be prepared for the camera 500b.

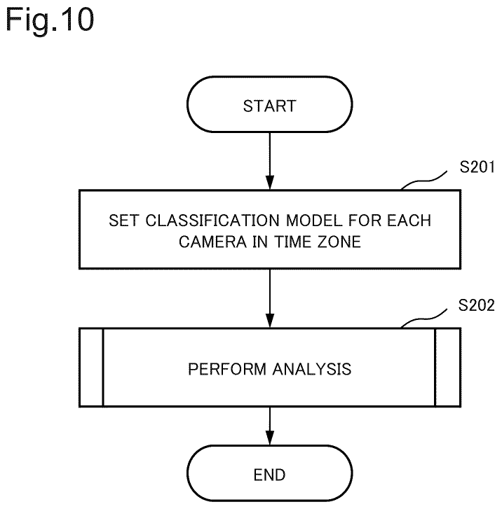

Next, operations of the present example embodiment will be described in detail with reference to the drawings. FIG. 10 is a flowchart illustrating the operations of the traffic flow analysis device 100a according to the second example embodiment of the present invention. Referring to FIG. 10, first, the traffic flow analysis device 100a selects a classification model related to a time zone in which analysis is performed for each camera, and sets the classification model in the identification means 102 (step S201).

Thereafter, the traffic flow analysis device 100a repeats the process of detecting a pedestrian appearing in the image captured by each of the cameras 500a and 500b and identifying his or her attribute (step S202).

As described above, the model selection means 113 selects an appropriate classification model according to the installation position of the camera 500a and the time zone. For example, as illustrated in FIG. 9, even in the same camera 500a, since there are many commuters, that is many adults, at 8:00-10:00 in the morning, the classification model A0810 specialized for the time zone is selected. On the other hand, at 14:00-16:00 in the afternoon, children and elderly people pass through, so that the classification model A1416 specialized for the time zone is selected.

According to the present example embodiment operating as described above, it is possible to improve the identification accuracy of the attribute of the pedestrian in a place where the tendency may change depending on the time zone. The reason is that a configuration in which a classification model considering a time zone is prepared and selected is used.

### Third Example Embodiment

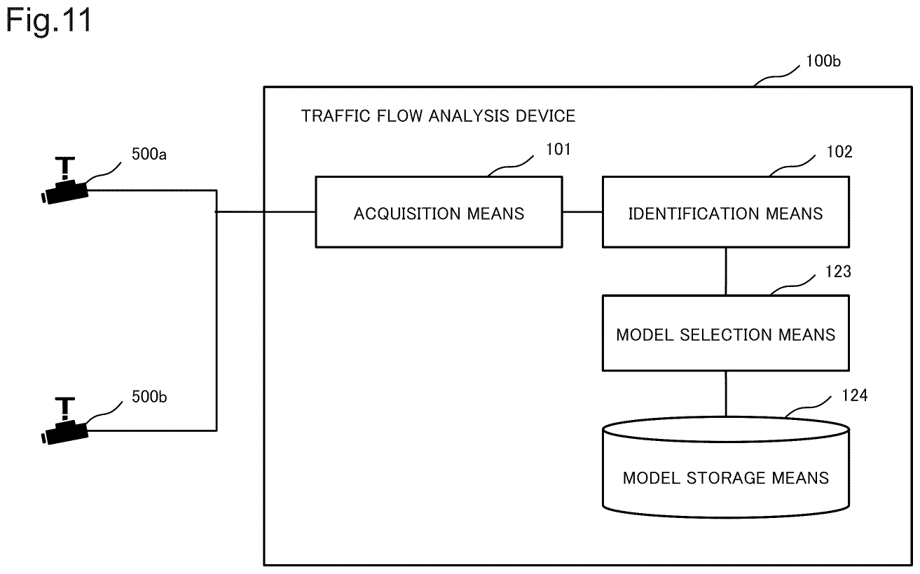

Next, a third example embodiment of the present invention in which a classification model is dynamically selected using a model selection rule for selecting the classification model based on a tendency of an attribute identified by an identification means will be described in detail with reference to the drawings. FIG. 11 is a block diagram illustrating a configuration of a traffic flow analysis device 100b according to the third example embodiment of the present invention. A difference from the traffic flow analysis device of the first example embodiment illustrated in FIG. 2 is that a classification model for each flow of people tendency is stored in a model storage means 124, and a model selection means 123 selects the classification model based on the latest flow of people analysis result in addition to the installation positions of the cameras 500a and 500b. Since other configurations are similar to those of the first example embodiment, description thereof will be omitted, and differences will be mainly described below.

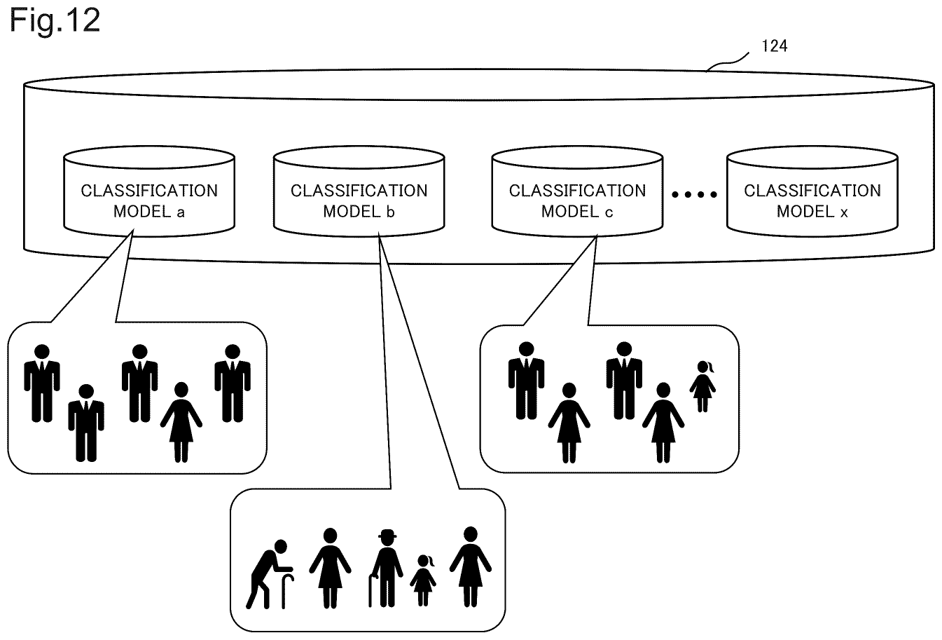

As illustrated in FIG. 12, in the present example embodiment, the model storage means 124 stores a plurality of classification models for respective flow of people tendencies, such as a classification model a to a classification model x. The classification model a is a classification model tuned for identifying an attribute of a pedestrian under a situation where adult males are passing. Similarly, the classification model b is a classification model tuned for identifying an attribute of a pedestrian under a situation where the attribute variation is large. The classification model c is a classification model tuned for identifying an attribute of a pedestrian in a situation where adult males and adult females are passing in a similar number.

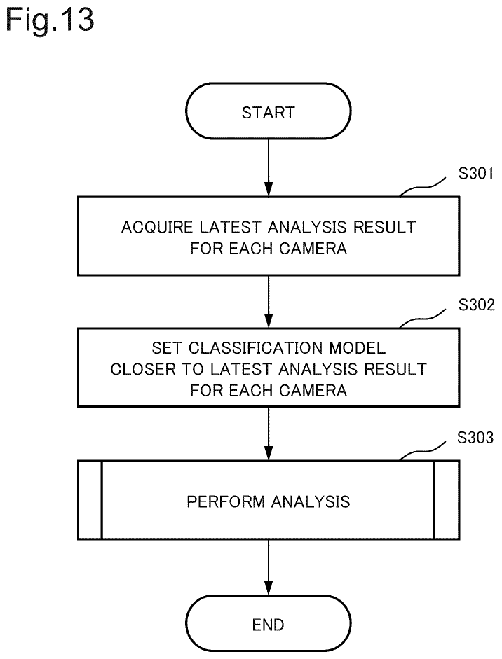

Next, operations of the present example embodiment will be described in detail with reference to the drawings. FIG. 13 is a flowchart illustrating the operations of the traffic flow analysis device 100b according to the third example embodiment of the present invention. Referring to FIG. 13, first, the traffic flow analysis device 100b acquires the latest analysis result for each of the cameras 500a and 500b (step S301). The latest analysis result may be stored by the traffic flow analysis device 100b or may be managed by a higher-level device that has received the analysis result from the traffic flow analysis device 100b.

Next, the traffic flow analysis device 100b selects a classification model close to the latest analysis result for each of the cameras 500a and 500b, and sets the classification model in the identification means 102 (step S302). For example, in a case where there are many adult men in the latest analysis result of the image of the camera 500a, the model selection means 123 selects the classification model a tuned for identifying the attribute of the pedestrian in a situation where there are many adult men. Similarly, in a case where the variation in the attribute is large in the latest analysis result of the image of the camera 500b, the model selection means 123 selects the classification model b.

Thereafter, the traffic flow analysis device 100b repeats the process of detecting a pedestrian appearing in the image captured by each of the cameras 500a and 500b and identifying an attribute of the pedestrian (step S303).

According to the present example embodiment operating as described above, the identification accuracy of the attribute of the pedestrian can be further improved, compared with the that of the first example embodiment. The reason is that a configuration is used in which a plurality of types of classification models whose targets are different is prepared, and the classification model is selected based on the tendency of a flow of people obtained in the latest analysis.

### Fourth Example Embodiment

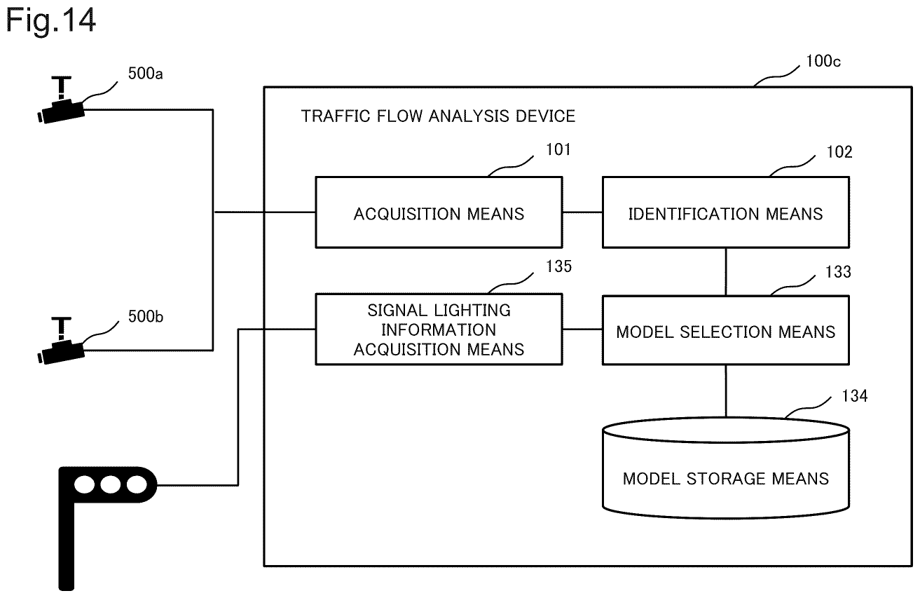

Next, a fourth example embodiment of the present invention in which a classification model is selected using a model selection rule for selecting a classification model based on a color of lighting of a traffic signal installed around a camera will be described in detail with reference to the drawings. FIG. 14 is a diagram illustrating a configuration of a traffic flow analysis device 100c according to the fourth example embodiment of the present invention. A first difference from the traffic flow analysis device of the first example embodiment illustrated in FIG. 2 is that a signal lighting information acquisition means 135 is added. A second difference is that a model storage means 134 stores a classification model for each color of lighting of a traffic signal, and a model selection means 133 selects the classification model based on the color of lighting of the traffic signal in addition to the installation positions of the cameras 500a and 500b. Since other configurations are similar to those of the first example embodiment, description thereof will be omitted, and differences will be mainly described below.

The signal lighting information acquisition means 135 acquires the color of lighting of the traffic signal at the intersection where the cameras 500a and 500b are installed. The method of acquiring the color of lighting of the traffic signal by the signal lighting information acquisition means 135 can include a method of acquiring signal control information from a signal control device that controls the traffic signal, or a method of determining from the color of lighting equipment of the traffic signal appearing in the image captured by each of the cameras 500a and 500b.

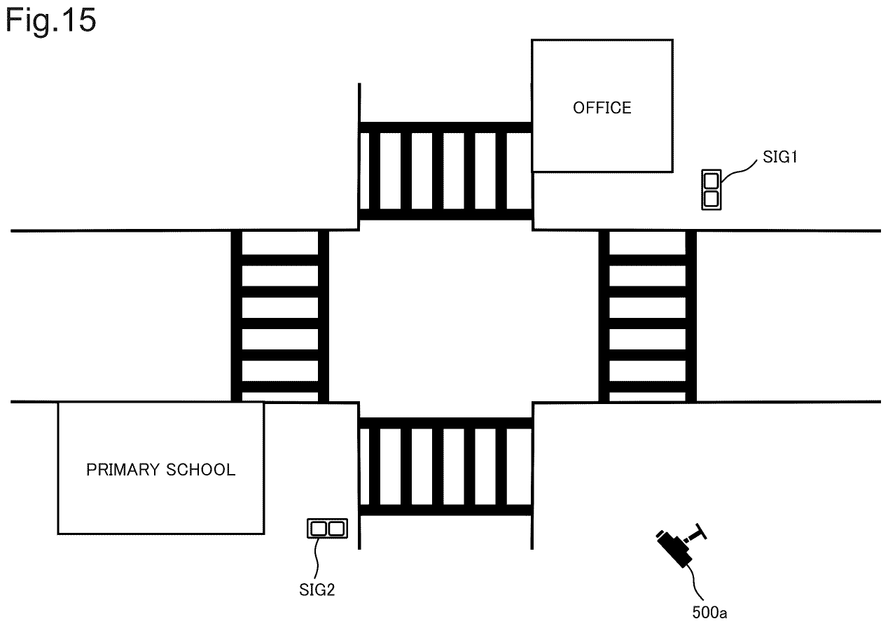

FIG. 15 is a diagram illustrating an example of arrangement of facilities around an intersection where the camera 500a is installed. In the example of FIG. 15, there is an office ahead of a pedestrian traffic signal SIG1, and there is an elementary school ahead of a pedestrian traffic signal SIG2. Therefore, when the pedestrian traffic signal SIG1 turns blue, the pedestrian moving in and out of the office is captured by the camera 500a. Thereafter, when the pedestrian traffic signal SIG2 turns blue, a child or the like attending an elementary school is imaged by the camera 500a.

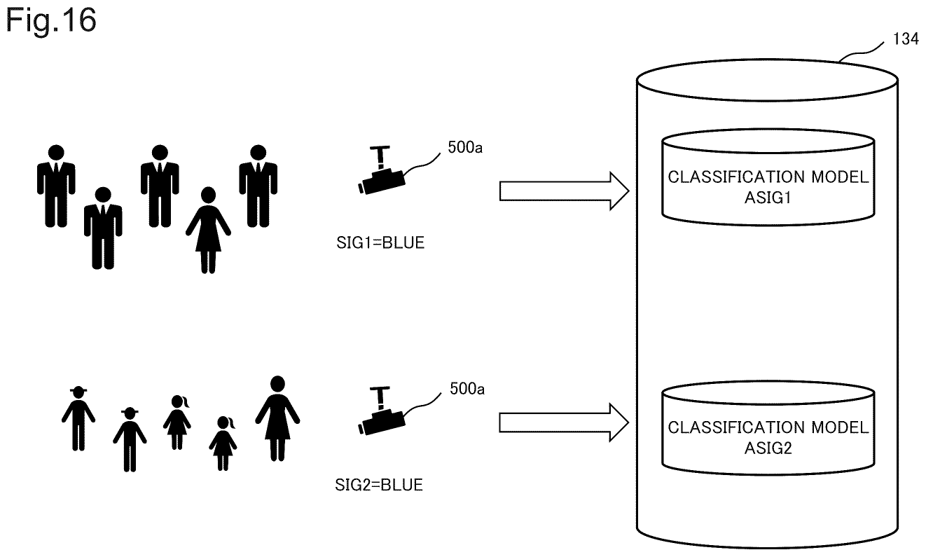

As illustrated in FIG. 16, the model storage means 134 of the present example embodiment stores two classification models: a classification model ASIG1 and a classification model ASIG2. The classification model ASIG1 is a classification model tuned for identifying an attribute of a pedestrian captured in a period in which the pedestrian traffic signal SIG1 is blue. Similarly, the classification model ASIG2 is a classification model tuned for identifying an attribute of a pedestrian captured in a period in which the pedestrian traffic signal SIG2 is blue. Such a classification model can be actually created by performing machine learning using an image captured at the timing zone of each signal lighting by the camera 500a (or an image captured at a similar position) and actual flow of people data (correct answer data) as teacher data. In the example of FIG. 16, the classification models applied when the pedestrian traffic signals SIG1 and SIG2 are each blue are illustrated, but classification models of the other lighting states may be held. In the examples of FIGS. 15 and 16, the classification model for the camera 500b is omitted, but a classification model for each color of lighting of a traffic signal may be prepared as in the camera 500b.

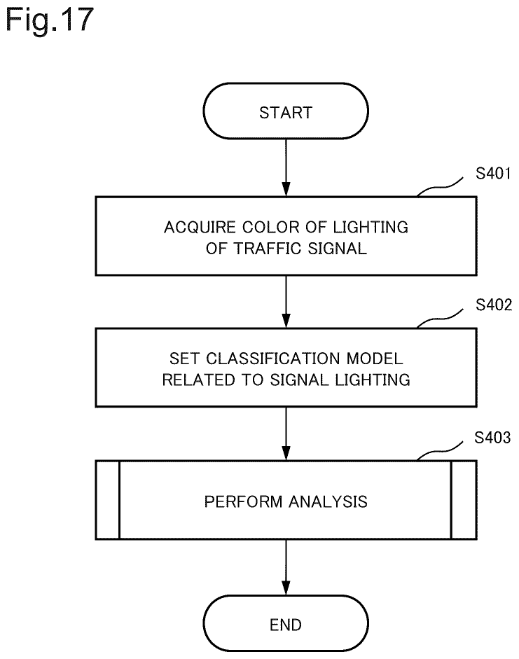

Next, operations of the present example embodiment will be described in detail with reference to the drawings. FIG. 17 is a flowchart illustrating the operations of the traffic flow analysis device 100c according to the fourth example embodiment of the present invention. Referring to FIG. 17, first, the traffic flow analysis device 100c acquires the color of lighting of the pedestrian traffic signal for each camera (step S401).

Next, the traffic flow analysis device 100c selects a classification model related to the color of lighting of the pedestrian traffic signal for each camera, and sets the classification model in the identification means 102 (step S402).

Thereafter, the traffic flow analysis device 100c repeats the process of detecting a pedestrians appearing in the image captured by each of the cameras 500a and 500b using the selected classification model and identifying an attribute of the pedestrian (step S403).

As described above, the model selection means 133 selects an appropriate classification model according to the installation position of the camera 500a and the color of lighting of the pedestrian traffic signal. For example, as illustrated in FIG. 16, in a case where the pedestrian traffic signal SIG1 is blue at the intersection where the camera 500a is set, the classification model ASIG1 specialized for the period is selected. On the other hand, in a case where the pedestrian traffic signal SIG2 is blue at the intersection where the camera 500a is installed, the classification model ASIG2 specialized for the period is selected.

According to the present example embodiment operating as described above, the identification accuracy of the attribute of the pedestrian can be further improved, compared with the that of the first example embodiment. The reason is that a configuration is used in which a classification model in consideration of the color of lighting of the traffic signal that affects a flow of people, in addition to the position of the camera, is prepared, and is selected.

### Fifth Example Embodiment

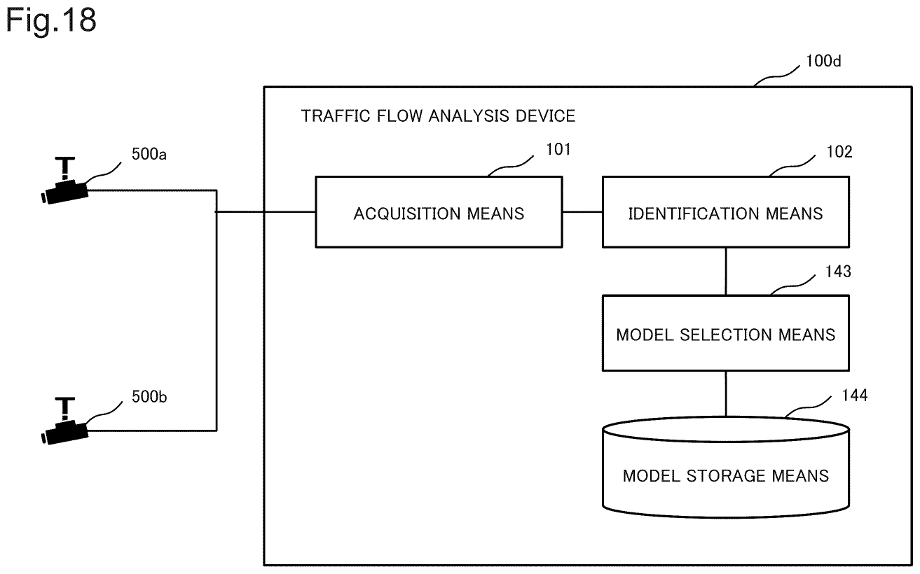

Next, a fifth example embodiment of the present invention in which an attribute of a vehicle is analyzed as a traffic flow will be described in detail with reference to the drawings. FIG. 18 is a block diagram illustrating a configuration of a traffic flow analysis device 100d according to the fifth example embodiment of the present invention. A difference from the traffic flow analysis device of the first example embodiment illustrated in FIG. 2 is that a vehicle classification model is stored in a model storage means 144, and a model selection means 143 selects a classification model according to installation positions of the cameras 500a and 500b. Since other configurations are similar to those of the first example embodiment, description thereof will be omitted, and differences will be mainly described below.

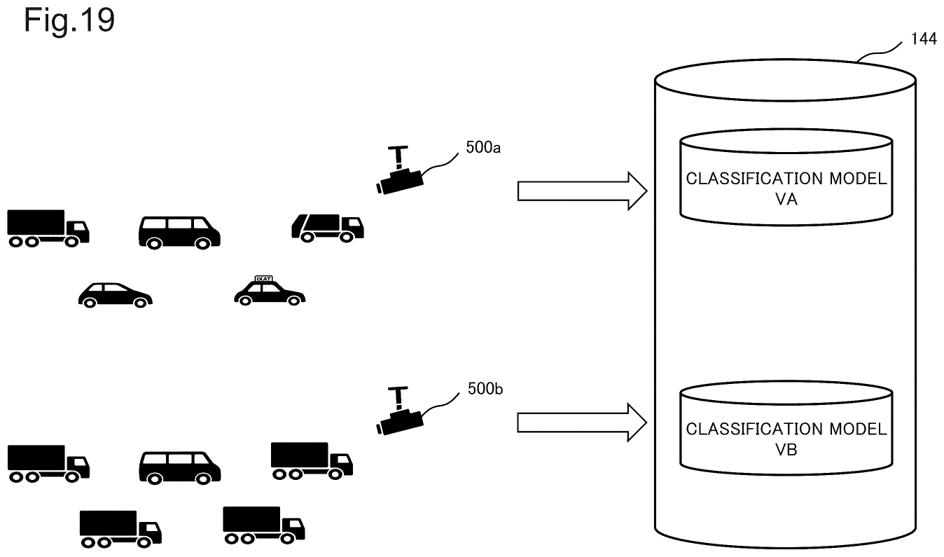

As illustrated in FIG. 19, in the present example embodiment, the model storage means 144 stores a classification model VA and a classification model VB. The classification model VA is a classification model tuned for identifying an attribute of a vehicle captured by the camera 500a. Such a classification model can be created by actually performing machine learning using an image captured by the camera 500a (or an image captured at a similar position) and actual traffic flow data (correct answer data). Similarly, the classification model VB is a classification model tuned for identification of an attribute of a vehicle captured by the camera 500b. The vehicle may include a bicycle, an electric kickboard, and other light vehicles.

The model selection means 143 of the present example embodiment selects a classification model using a model selection rule for selecting an appropriate classification model according to the installation positions of the cameras 500a and 500b. Specifically, the model selection means 143 selects the classification model VA for the image captured by the camera 500a, and selects the classification model VB for the image captured by the camera 500b.

Operations of the present example embodiment is similar to that of the first example embodiment, and as illustrated in FIG. 7, the traffic flow analysis device 100d selects a classification model for each camera and sets the classification model in the identification means 102 (step S101). Thereafter, the traffic flow analysis device 100d repeats the process of detecting a pedestrian appearing in the image captured by each of the cameras 500a and 500b and identifying his or her attribute (step S102).

As described above, the present invention can also be applied to a traffic flow analysis device that detects a vehicle and identifies its attribute. In the present example embodiment, as in the second to fourth example embodiments with respect to the first example embodiment, it is possible to prepare a classification model according to a time zone, an analysis result of a latest traffic flow, and a color of lighting of a traffic signal, and change or develop a mode for selecting these.

Although the example embodiments of the present invention have been described above, the present invention is not limited to the above-described example embodiments, and further modifications, substitutions, and adjustments can be made without departing from the basic technical idea of the present invention. For example, the network configuration, the configuration of respective elements, and the expression form of data illustrated in the drawings are examples for assisting the understanding of the present invention, and are not limited to the configurations illustrated in the drawings.

For example, in each of the above example embodiments, an example in which the analysis target is a pedestrian or a vehicle is described, but the analysis target is not particularly limited. The analysis target may be limited by a specific sex, age, presence or absence of a handicap, or the like.

In addition, each of the above-described example embodiments is merely an example, and can be changed to a configuration in which the traffic flow analysis device 100 selects an identification method such as a classification model or a processing algorithm under various conditions. For example, the traffic flow analysis device 100 can select a classification model under an any combination condition such as a position where an image is captured, a time zone, or a latest tendency.

### (Hardware Configuration)

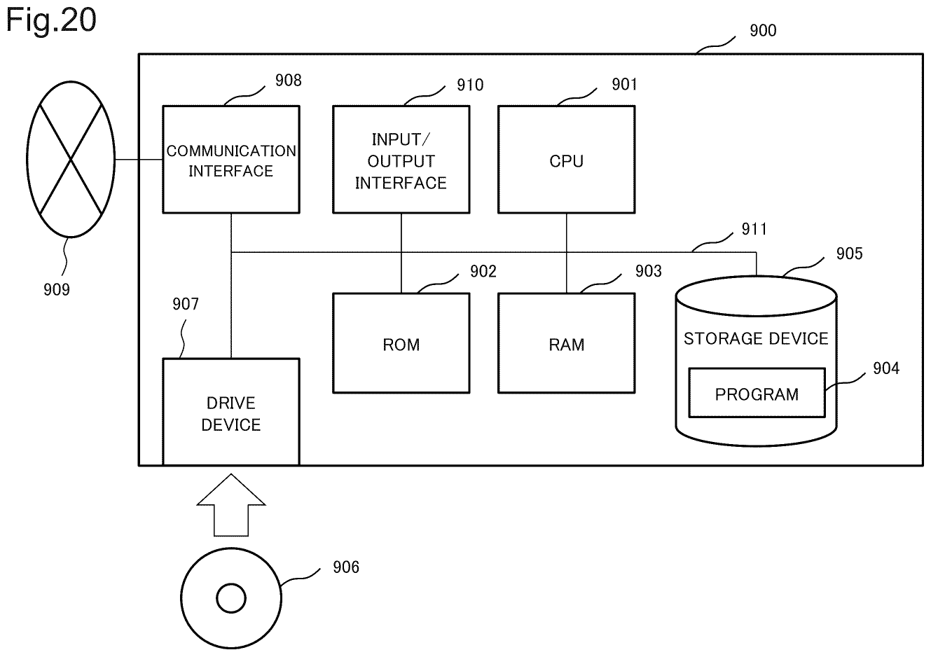

In each example embodiment of the present disclosure, each component of each device indicates a block of a functional unit. Part or all of each component of each device is achieved by, for example, an any combination of an information processing device 900 and a program as illustrated in FIG. 20. FIG. 20 is a block diagram illustrating an example of a hardware configuration of the information processing device 900 that achieves each component of each device. The information processing device 900 includes the following configuration as an example.
Central processing unit (CPU) 901
Read only memory (ROM) 902
Random access memory (RAM) 903
Program 904 loaded to RAM 903
Storage device 905 storing program 904
Drive device 907 reading and writing program recording medium 906
Communication interface 908 connected with communication network 909
Input/output interface 910 for inputting/outputting data
Bus 911 connecting respective components

Each component of each device in respective example embodiments is achieved by the CPU 901 acquiring and executing the program 904 for achieving these functions. That is, the CPU 901 of FIG. 20 may execute the vehicle detection program and the determination program to perform update processing of each calculation parameter stored in the RAM 903, the storage device 905, or the like. The program 904 for implementing the function of each component of each device is stored in advance in a program recording medium such as the storage device 905 or the ROM 902, and is read by the CPU 901 as necessary. The program 904 may be supplied to the CPU 901 via the communication network 909, or may be stored in advance in the program recording medium 906, and the drive device 907 may read the program and supply the program to the CPU 901.

The program 904 can display the processing result including the intermediate state for each stage via the display device as necessary, or can communicate with the outside via the communication interface. The program 904 can be recorded on a computer-readable (non-transitory) program recording medium.

There are various modifications of the implementation method of each device. For example, each device may be achieved by an any combination of the information processing device 900 and the program separate for each component. A plurality of components included in each device may be achieved by any combination of one information processing device 900 and a program. That is, the present invention can be achieved by a computer program that causes the communication terminal, the network control device, and the processor mounted in these devices described in the first to third example embodiments to execute each of the above-described processes using the hardware.

Part or all of each component of each device is achieved by another general-purpose or dedicated circuit, processor, or the like, or a combination thereof. These may be configured by a single chip or may be configured by a plurality of chips connected via a bus.

Part or all of each component of each device may be achieved by a combination of the above-described circuit or the like and the program.

In a case where part or all of each component of each device is achieved by a plurality of information processing devices, circuits, and the like, the plurality of information processing devices, circuits, and the like may be disposed in a centralized manner or in a distributed manner. For example, the information processing device, the circuit, and the like may be achieved as a form in which each of the information processing device, the circuit, and the like is connected via a communication network, such as a client and server system, a cloud computing system, and the like.

Each of the above-described example embodiments is a preferred example embodiment of the present disclosure, and the scope of the present disclosure is not limited only to each of the above-described example embodiments. That is, it is possible for those skilled in the art to make modifications and substitutions of the above-described example embodiments without departing from the gist of the present disclosure, and to construct a mode in which various modifications are made.

Some or all of the above example embodiments may be described as the following Supplementary Notes, but are not limited to the following.

### [Supplementary Note 1]

A traffic flow analysis device including
an acquisition means for acquiring an image from a camera installed at a location where a moving object subject to traffic flow analysis is configured to be imaged,
a storage means for storing a plurality of types of identification methods for identifying an attribute of the moving object captured by the camera,
a selection means for selecting an identification method suitable for a tendency of the moving object captured by the camera from the plurality of types of identification methods stored in the storage means, and
an identification means for identifying a moving object appearing in the acquired image and an attribute of the moving object using the identification method selected by the selection means.

### [Supplementary Note 2]

The selection means of the traffic flow analysis device described above may be configured to select the identification method based on a position of the camera.

### [Supplementary Note 3]

The selection means of the traffic flow analysis device described above may be configured to select the identification method based on a time zone in which the image is captured.

### [Supplementary Note 4]

The selection means of the traffic flow analysis device described above may be configured to select the identification method based on a tendency of an attribute identified by the identification means.

### [Supplementary Note 5]

The selection means of the traffic flow analysis device described above may be configured to select the identification method based on a color of lighting of a traffic signal installed around the camera.

### [Supplementary Note 6]

The identification method selected by the traffic flow analysis device described above may include a classification model or a processing algorithm for identifying an attribute of a moving object captured by a camera.

### [Supplementary Note 7]

In the traffic flow analysis device described above,
a plurality of types of the classification models or the processing algorithms is created based on a tendency of a moving object captured by the camera, the tendency being investigated in advance, and
the selection means may be configured to select, using a selection rule determined to select a classification model or a processing algorithm suitable for a tendency of a moving object captured by the camera from the plurality of types of classification models or processing algorithms, the classification model or the processing algorithm.

### [Supplementary Note 8]

In the traffic flow analysis device described above,
the moving object may include a person, and the classification model may include a classification model created by machine learning using statistical data of a flow of people at a position where the camera is installed as teacher data.

### [Supplementary Note 9]

In the traffic flow analysis device described above,
the moving object may include a person, and the classification model may be created by machine learning using statistical data of a flow of people for each time zone, the flow of people being imaged by the camera, as teacher data.

### [Supplementary Note 10]

A traffic flow analysis method including
selecting, from a plurality of types of identification methods stored in a storage means storing the plurality of types of identification methods for identifying an attribute of a moving object captured by the camera installed at a location where the moving object subject to traffic flow analysis is configured to be imaged, an identification method suitable for a tendency of the moving object captured by the camera,
acquiring an image from the camera, and
identifying an attribute of a moving object appearing in the acquired image using the selected identification method.

### [Supplementary Note 11]

A program recording medium storing a program for causing a computer to execute the steps of
selecting, from a plurality of types of identification methods stored in a storage means storing the plurality of types of identification methods for identifying an attribute of a moving object captured by the camera installed at a location where the moving object subject to traffic flow analysis is configured to be imaged, an identification method suitable for a tendency of the moving object captured by the camera,
acquiring an image from the camera, and
identifying an attribute of a moving object appearing in the acquired image using the selected identification method.

The forms of the Supplementary Notes 10 to 11 can be expanded to the forms of the Supplementary Notes 2 to 9, as in the Supplementary Note 1.

The disclosure of the above PTL is incorporated herein by reference, and can be used as a basis or part of the present invention as necessary. Within the frame of the entire disclosure (including the claims) of the present invention, it is possible to change and adjust the example embodiments or examples further based on of the basic technical idea thereof. Various combinations or selections (including partial deletions) of various disclosure elements (respective elements of each claim, respective elements of each example embodiment or example, respective elements of each drawing, and the like are included) can be made within the frame of the disclosure of the present invention. That is, it goes without saying that the present invention includes various modifications and corrections that can be made by those of ordinary skill in the art in accordance with the entire disclosure including the claims and the technical idea. Specifically, for numerical ranges set forth herein, any numerical value or sub-range included within the range should be construed as being specifically described, even when not stated otherwise. Furthermore, it is also deemed that in the matters disclosed in the document cited above, using part or all of the matters disclosed in the document in combination with the matters described in the present specification as part of the disclosure of the present invention according to the gist of the present invention as necessary is included in the matters disclosed in the present application.

### REFERENCE SIGNS LIST

500a, 500b camera
10, 100, 100a, 100b, 100c, 100d traffic flow analysis device
11, 101 acquisition means
12, 102 identification means
13 selection means
14 storage means
103, 113, 123, 133, 143 model selection means
104, 114, 124, 134, 144 model storage means
135 signal lighting information acquisition means
900 information processing device
901 central processing unit (CPU)
902 read only memory (ROM)
903 random access memory (RAM)
904 program
905 storage device
906 program recording medium
907 drive device
908 communication interface
909 communication network
910 input/output interface
911 bus
SIG1, SIG2 pedestrian traffic signal
STA station

What is claimed is:

1. A traffic flow analysis device comprising:
a memory configured to store instructions; and
one or more processors configured to execute the instructions to:
acquire an image from a camera installed at a location where a moving object subject to traffic flow analysis is configured to be imaged;
store a plurality of types of identification methods for identifying an attribute of the moving object captured by the camera;
select an identification method suitable for a tendency of the moving object captured by the camera from the plurality of types of stored identification methods; and
identify a moving object appearing in the acquired image and an attribute of the moving object using the selected identification method.

2. The traffic flow analysis device according to claim 1, wherein
the one or more processors are further configured to:
select the identification method based on a position of the camera.

3. The traffic flow analysis device according to claim 1, wherein
the one or more processors are further configured to:
select the identification method based on a time zone in which the image is captured.

4. The traffic flow analysis device according to claim 1, wherein
the one or more processors are further configured to:
select the identification method based on a tendency of the identified attribute.

5. The traffic flow analysis device according to claim 1, wherein
the one or more processors are further configured to:
select the identification method based on a color of lighting of a traffic signal installed around the camera.

6. The traffic flow analysis device according to claim 1, wherein the identification method includes a classification model or a processing algorithm for identifying an attribute of a moving object captured by a camera.

7. The traffic flow analysis device according to claim 6, wherein.
a plurality of types of the classification models or the processing algorithms is created based on a tendency of the moving object captured by the camera, the tendency being investigated in advance, and
the one or more processors are further configured to:
select, using a selection rule determined to select a classification model or a processing algorithm suitable for the tendency of the moving object captured by the camera from the plurality of types of classification models or processing algorithms, the classification model or the processing algorithm.

8. The traffic flow analysis device according to claim 7, wherein
the moving object includes a person, and the classification model includes a classification model created by machine learning using statistical data of a flow of people at a position where the camera is installed as teacher data.

9. The traffic flow analysis device according to claim 7, wherein the moving object includes a person, and the classification model is created by machine learning using statistical data of a flow of people for each time zone, the flow of people being imaged by the camera, as teacher data.

10. A traffic flow analysis method comprising:
selecting, from a plurality of types of identification methods for identifying an attribute of a moving object captured by a camera installed at a location where the moving object subject to traffic flow analysis is configured to be imaged, an identification method suitable for a tendency of the moving object captured by the camera;
acquiring an image from the camera; and
identifying an attribute of a moving object appearing in the acquired image using the selected identification method.

11. A non-transitory computer-readable program recording medium storing a program for causing a computer to execute:
selecting, from a plurality of types of identification methods for identifying an attribute of a moving object captured by the camera installed at a location where the moving object subject to traffic flow analysis is configured to be imaged, an identification method suitable for a tendency of the moving object captured by the camera;
acquiring an image from the camera; and
identifying an attribute of a moving object appearing in the acquired image using the selected identification method.
